(19) United States
(12) Patent Application Publication
(10) Pub. No.: US 2008/0104039 A1
(43) Pub. Date: May 1, 2008

(54) SYSTEM AND METHOD FOR RESOURCE MANAGEMENT

(76) Inventor: Linda Lowson, Huntington, NY (US)

Correspondence Address: LINDA M. LOWSON, 223 WALL STREET PMB 134, HUNTINGTON, NY, 11743, US

(21) Appl. No.: 11/966,569

(22) Filed: Dec. 28, 2007

Related U.S. Application Data
(63) Continuation-in-part of application No. 11/164,477, filed on Nov. 23, 2005.
(60) Provisional application No. 60/630,774, filed on Nov. 24, 2004.

(51) Int. Cl. G06F 7/06

(52) U.S. Cl. 707/3; 706/50; 707/E17.014

(57) ABSTRACT

A method for creating and maintaining a search knowledge-based system with respect to company, product and service resources within an industry, using a knowledge base data content structure having categories, rule sets, search parameters, data sources, and data content input from the plurality of data sources. The method assigns an activity rule set to each search parameter, which rule set generates a user query set, and assigns a user need rule set to each user query set. User query set responses are received, and the user need rule set is applied to the user query set responses to generate a knowledge base analysis rule set which embodies industry knowledge. The knowledge base analysis rule set applicable to the user query set responses is run on the knowledge base to generate a result set, and the result set is output.

### REFERENCE TO RELATED APPLICATIONS

This is a continuation-in-part of parent patent application Ser. No. 11/164,477, entitled “SYSTEM AND METHOD FOR RESOURCE MANAGEMENT” filed Nov. 23, 2005. This parent patent at application claimed the benefit under 35 USC §119(e) of Provisional Application 60/630,774 filed Nov. 24, 2004. The aforementioned application(s) are hereby incorporated herein by reference.

### BACKGROUND OF THE INVENTION

1. Field of the Invention

The invention relates to the management of company, product and service resources, and more particularly, to an improved system and method that provides an institutional-quality process for the sourcing, evaluation, purchase, management, education and administration of company, product and service resources within specific industries and customer markets.

2. Description of Related Art

As demonstrated by the recent success enjoyed by companies that provide web-based search capabilities, both the individual and business consumer today continuously need speedy, convenient, efficient access to company, product and service resources for a diverse and ever-changing range of personal and business needs. The quantity and specialization of company, product and service resources, together with the need and ability to access both global and local resources, have been increasing at a rapid rate, and will continue to increase for the foreseeable future. These market trends and market needs are driving the increasing need for a more sophisticated, standardized, automated, and customized tool for company, product and service resource sourcing, evaluation, purchase, management, administration, and education on an industry-specific basis.

The search results provided by current web-based search engines are based in large part upon a combination of computer algorithms, key word and metadata relevance, popularity of a web page (number of relevant visitors), behavioral click-stream information, advertiser conversion rates, price, and/or feedback from one's peers or other designated “community” (the latter is a phenomenon also referred to as “social intelligence”).

The “specialized” search engines that focus on specific industries or customer markets may provide company, product or service ratings or reviews based upon price and basic product or service characteristics, but in most cases any qualitative “evaluation” is based upon personal opinions of a narrowly defined web user population (social intelligence) and not upon industry-specific qualitative and/or quantitative evaluation standards, guidelines, or reference points in retrieving product or service search results.

Conceptually and technologically, this current search functionality (i) lacks proper industry-specific and/or user-based qualitative standards and guidelines in retrieving and ranking search results; (ii) lacks independent, standards-based evaluation of company, product and service resources for specific user needs; and (iii) lacks proper user education and guidance in the search process. Consequentially, current search functionality provides the user, in many if not most cases, (a) with search results that are inaccurate, imprecise, unreliable, superficial, and/or useless in sourcing, evaluating, and selecting the proper resources; (b) with no ability to ascertain whether the search results retrieved fulfill the user's requirements as to quality or other characteristics or attributes he is seeking in the resources; and (c) with no ability to ascertain whether the user is in fact conducting the right search process to fulfill his needs.

Historically, before the advent of the Internet and web-based search engines, the critical process of sourcing, evaluating, and selecting company, product and service resources, by both business and individual resource users, was driven largely by word-of-mouth, media advertising, vendor marketing prowess, consultant bias, and reciprocal business arrangements. The process was extremely inefficient, haphazard, merely expedient, and governed by no clear-cut industry-specific guidelines or standards. This lack of an institutional-quality resource management process still exists today as a prevalent market practice, supplemented by the “process-deficient” web-based search engine capabilities described above. More specifically, the ability to intelligently, efficiently, and economically manage product and service resources for industry-specific user needs through the use of a technology-based tool and/or information technology platform does not exist today.

This resource management process deficiency has been detrimental to both the resource user and the resource provider. For the resource user, it has resulted in (i) significant underutilization and imprecise use of available resource options; (ii) mediocre to substandard service performance and service quality from service providers; (iii) lack of best pricing; and (iv) an extremely fragmented, non-transparent marketplace within specific industries that prevents the resource user from gaining access to information that can improve his resource experience and performance results. For the resource provider, it has resulted in loss of market share and/or loss of pricing power by “best-of-breed” resource providers in favor of less-than-optimal resource providers for a given resource user need. This resource management process deficiency has prevailed for decades, despite the fact that the user's resource experience and actual performance results are based in large part upon the quality and other attributes, timeliness, and precision of the resources deployed.

An exemplary illustration of the detriment to resource users and resource providers caused by this resource management process deficiency can be found in the financial services industry. Individuals and businesses alike need to identify, select, and manage a broad range of financial services providers to help them manage their financial and non-financial assets. This fundamental market need has been growing in size and intensity as both the resource user and the resource provider marketplaces have continued to experience unprecedented growth over the last decade, driven by strong secular growth trends. At the same time, the financial services industry has developed widespread systemic problems, specifically, rampant conflicts of interest, self-dealing in fiduciary relationships, and similar shortcomings and ethical abuses by financial services providers, to the significant detriment of the financial services consumer. These abuses have prevailed because the consumer lacks the ability to efficiently and economically access accurate, comprehensive resource information and independent evaluations of these resources. The current sources of resource information consist of numerous, diverse, largely biased, and incomplete sources, including word-of-mouth, resource provider web sites, industry and news publications and information services, industry trade organizations, and media advertising. Examples of specific market practices resulting from this financial services resource management process deficiency are described below.

Many financial services providers are driven by a culture, mentality, and performance orientation based primarily upon one key metric: sales of their products and services (including accumulation of assets under management), since revenues and profits drive their bonuses and other compensation. The client's best interests are subordinated to this objective, and the client's needs are in many cases adapted to the financial services provider's compensation scheme.

Many individual consumers now rely primarily upon their friends and family (those they trust most) when selecting financial services providers. However, these sources generally base their resource recommendations almost solely upon personal experience and not upon objective market research or standards-driven evaluation. Thus, many high-quality financial services providers that should be evaluated by the resource user remain unknown to the resource user and/or are not considered in the resource selection process.

This financial services resource management process deficiency has negatively impacted both the financial services resource user and the financial services resource provider. For the resource user, the resource provider abuses described above have compromised the quality of the customer experience and the actual benefits (including pricing) and performance the customer has received. For the resource provider, a lack of trust by financial services consumers has caused a steady decrease in pricing power, brand strength, and customer loyalty. Thus, the invention presents an institutional-quality process that is extremely timely in the current financial services environment, an environment besieged by conflicts of interest, lack of ethics, and lack of trust.

Sundaresan (U.S. Patent Application Publication Number 2003/0033299) shows a simple search process for finding businesses based on customer satisfaction, user feedback and web data sources, and knowledge base evaluation to generate business rating search results. Sundaresan does not use search criteria to generate an activity rule set which generates a user query set, which in turn generates a user need rule set which generates a knowledge base analysis rule set which is applied to the knowledge base to generate a comprehensive result set for the user's precise resource needs, nor does Sundaresan show a search process that uses rule sets containing industry knowledge to assess the user's precise needs, to evaluate the resources based upon the user's precise needs, and to provide education and guidance to the user in the search process.

Noetzold et al., (U.S. Patent Application Publication Number 2004/0133439) shows a system for determining and rating the credit quality of companies, including assessing what could impact future financial performance. Noetzold does not show a system for evaluating commercial (marketplace) resources. Further, Noetzold updates the corporate rating result based upon updated data content which may change the values of the factors or ratios, but does not change or update rule sets (e.g., factors and ratios) (and also does not update categories, search parameters, or data sources) of the knowledge base data content structure, based upon updated knowledge base data content.

### SUMMARY OF THE INVENTION

The invention, hereinafter sometimes referred to as the “WRM SYSTEM”, is comprised of a web-based and/or computer-implemented system and method that provides an institutional-quality process for the sourcing, evaluation, purchase, management, education and administration of company, product and service resources within specific industries and customer markets.

As used herein, the term “search parameter” means any parameter used in a search or query.

The computer-implemented method of the invention creates and maintains a search knowledge-based system with respect to company, service and product resources within a specific industry, using a knowledge base data content structure comprised of a plurality of categories, a plurality of rule sets, a plurality of search parameters, a plurality of data sources, and data content input from the plurality of data sources; the rule sets comprising a plurality of user need rule sets. At least one search parameter is accepted from a user, which generates at least one user query set based upon the at least one search parameter. At least one user need rule set is assigned to each user query set, the user need rule set comprised of industry knowledge applicable to the user needs embodied in the user query set, and the at least one user query set is displayed to the user. User query set responses are received from the user in response to queries in the at least one user query set, and the at least one user need rule set is applied to the user query set responses to generate at least one knowledge base analysis rule set which embodies industry knowledge for fulfilling the user needs embodied in the user query set responses. The at least one knowledge base analysis rule set applicable to the user query set responses is run on the knowledge base to generate at least one result set, and the at least one result set is output. Alternatively, the rule sets further comprise a plurality of activity rule sets, each activity rule set is assigned to at least one search parameter and embodying industry knowledge applicable to the activity embodied in the search parameter; and the user query sets are generated by selecting at least one activity rule set based upon the at least one search parameter.

The method of the invention may be practiced as a system, in which the knowledge base is stored on a computer-readable medium, and the method is practiced at least in part by a programmed processor coupled to the knowledge base.

The search knowledge-based resource management system of the invention enables a user to receive the most accurate, precise, comprehensive, and highest quality search results, as well as industry knowledge, education, and guidance pertaining to his search needs. Additionally, the invention facilitates communication, information sharing, transactions, and collaborative activities among resource users and resource providers.

Among the characteristics which distinguish the invention from existing systems and methods and which produce the invention's institutional-quality search results are:
a. The method and system of the invention applies rule sets which incorporate industry knowledge to make a detailed and comprehensive assessment of the user's precise resource needs;
b. The method and system of the invention applies rule sets which incorporate industry knowledge in the evaluation of the knowledge base data content for the user's precise needs, and the factors, ratios, and values in the rule sets change based upon the user's precise needs;
c. The method and system of the invention updates the categories, search parameters, rule sets, and data sources comprising the knowledge base data content structure of the invention based upon updated knowledge base data content; and
d. The method and system of the invention generates results for a comprehensive range of user activity needs within a specific industry, i.e., a data content result set that may include industry knowledge education, search process guidance, resource sourcing and evaluation, and links to enable easy, efficient communication, information-sharing, transactions, and collaborative activities among resource users and resource providers, all of the foregoing being customized for the user's precise needs, and the user is expertly guided through the search process with the simple selection of a search parameter.

The system and method of the invention also may provide and facilitate consulting, advisory, product development, advertising, marketing, sales, distribution, customer servicing, customer management, and similar services for resource providers within a specific industry.

The system and method of the invention also may provide and facilitate, for resource users and resource providers within a specific industry, (i) interactive communications, including, for example, by email, instant messaging, and wireless communications; (ii) collaborative activities, including, for example, blogs and podcasts; and (iii) transactional activities, including, for example, direct purchase of resources, customer servicing, and contractual arrangements, between and among resource users and resource providers within a specific industry.

### DETAILED DESCRIPTION OF THE INVENTION

In an exemplary embodiment of the invention, the invention is comprised of the following technology components: (i) one or more search engines that search the invention's databases and/or the World Wide Web and/or private computer networks; (ii) one or more indexing engines, query managers, search results transformers, search result sorters, history managers, and graphical user interfaces; (iii) one or more databases and metadata repositories, residing on one or more public Web servers and/or private servers; (iv) rule sets and analytic templates, that, when applied to the database(s), generate a result or action that relates to the sourcing, evaluation, purchase, management, education and/or administration of company, product and service resources within a specific industry; (v) conventional data processing, data management and data warehousing application software components and tools, which may deploy open standards, such as an XML-enabled relational database management system (RDBMS) to store the cleansed data, an online analytical processing (OLAP) database and OLAP engine to enable multidimensional data analysis, and data transformation software to extract, transform, and load data between systems; and (vi) optional additional conventional software and hardware, such as user measurement and reporting software, transaction-based software, and email, telecommunication, audio/video/data transmission, networking, and security software and hardware.

In an exemplary embodiment of the invention, the invention's database(s) may be comprised of one or more of the following data content categories for a specific industry application of the invention: (i) information and analyses on specific company, product and service resources within specified business, product, and/or service categories and/or user need categories within the specific industry; (ii) information and analyses on resource users within the specific industry; (iii) information and analyses on customer markets within the specific industry; (iv) information and analyses on trends, business practices, and/or market practices within the specific industry; (v) resource user and resource provider feedback within the specific industry; (vi) qualitative and/or quantitative evaluation models, standards, policies, procedures, best practices, and/or standard operating procedures for the specific industry; and (vii) knowledge base analyses of the foregoing database components. This data content is hereinafter sometimes collectively referred to as the “WRM Knowledge Base”.

The method of the invention uses the following principal steps to create and maintain a search knowledge-based system with respect to company, service and product resources within a specific industry, using a knowledge base data content structure comprised of a plurality of categories, a plurality of rule sets, a plurality of search parameters, a plurality of data sources, and data content input from the plurality of data sources; the rule sets comprising a plurality of user need rule sets:
(a) accepting at least one search parameter from a user;
(b) generating at least one user query set based upon the at least one search parameter;
(c) assigning at least one user need rule set to each user query set, the user need rule set embodying industry knowledge applicable to the user needs embodied in the user query set;
(d) displaying the at least one user query set to the user.
(e) receiving user query set responses from the user in response to queries in the at least one user query set;
(f) applying the at least one user need rule set to the user query set responses to generate at least one knowledge base analysis rule set which embodies industry knowledge for fulfilling the user needs embodied in the user query set responses;
(g) running the at least one knowledge base analysis rule set applicable to the user query set responses on the knowledge base to generate at least one result set; and
(h) outputting the at least one result set.

Alternatively, the rule sets further comprise a plurality of activity rule sets, each activity rule set being assigned to at least one search parameter and embodying industry knowledge applicable to the activity embodied in the search parameter; and the user query sets are generated by:
(a) selecting at least one activity rule set based upon the at least one search parameter; and
(b) generating at least one user query set based upon the at least one activity rule set.

Optionally, at least one of the rule sets may incorporate one or more equations, factors, ratios, and/or values embodying at least one of: (a) resource provider evaluation criteria applicable to at least one of the following: business model, operational model, corporate governance, financial metrics, customer satisfaction measurement, and basic business data; (b) industry information and analysis; (c) industry standards; (d) industry policies; (e) industry procedures; (f) best practice standards; and (g) standard operating procedures.

Also optionally, the method also may update the knowledge base data content by at least one of adding, modifying, and deleting data content based upon at least one of (i) new data content input from the plurality of data sources, and (ii) new data content input from a new data source added to the plurality of data sources. This updating may be done at specified intervals, or as needed.

Also optionally, the method also may update the knowledge base data content structure by at least one of adding, modifying, and deleting at least one of the plurality of categories, the plurality of rule sets, the plurality of search parameters, and the plurality of data sources, based upon at least one of (i) new data content input from the plurality of data sources, and (ii) new data content input from a new data source added to the plurality of data sources. This updating may be done at specified intervals, or as needed.

Also, a user search history of a user of the system may be stored in the knowledge base. Also, a user analysis and/or a user profile may be produced, based upon the user search history, and then stored in the knowledge base. Also, this user analysis and/or user profile may be stored in the knowledge base as one of the plurality of data sources in the knowledge base data content structure.

The result set may include at least one of the following: (i) at least one of knowledge base data content, knowledge base analysis, knowledge base ranking, and knowledge base rating; (ii) a link to an external data entity; (iii) a link to a web site; and (iv) a link to a processor comprising a communications element.

The computer-implemented search knowledge-based system of the invention comprises:
a) a computer-readable knowledge base having a data content structure comprised of: (i) a plurality of categories, (ii) a plurality of rule sets comprising a plurality of user need rule sets, (iii) a plurality of search parameters, (iv) a plurality of data sources, and (v) data content input from the plurality of data sources;
b) at least one processor coupled to the knowledge base and comprising a communications element communicating with at least one user; the processor being programmed such that the processor:
   (i) accepts at least one search parameter from a user through the communications element;
   (ii) generates at least one user query set based upon the at least one search parameter;
   (iii) assigns at least one user need rule set to each user query set, the user need rule set embodying industry knowledge applicable to the user needs embodied in the user query set;
   (iv) displays the at least one user query set to the user through the communications element;
   (v) receives user query set responses from the user through the communications element, in response to queries in the at least one user query set;
   (vi) applies the at least one user need rule set to the user query set responses to generate at least one knowledge base analysis rule set which embodies industry knowledge for fulfilling the user needs embodied in the user query set responses;
   (viii) runs the at least one knowledge base analysis rule set applicable to the user query set responses on the knowledge base to generate at least one result set; and
   (ix) outputs the at least one result set to the user through the communications element.

Alternatively, the rule sets further comprise a plurality of activity rule sets, each activity rule set being assigned to at least one search parameter and embodying industry knowledge applicable to the activity embodied in the search parameter; and the user query sets are generated by: (a) selecting at least one activity rule set based upon the at least one search parameter; and (b) generating at least one user query set based upon the at least one activity rule set.

Optionally, at least one of the rule sets may incorporate one or more equations, factors, ratios, and/or values embodying at least one of: (a) resource provider evaluation criteria applicable to at least one of the following: business model, operational model, corporate governance, financial metrics, customer satisfaction measurement, and basic business data; (b) industry information and analysis; (c) industry standards; (d) industry policies; (e) industry procedures; (f) best practice standards; and (g) standard operating procedures.

The result set may include at least one of the following: (i) at least one of knowledge base data content, knowledge base analysis, knowledge base ranking, and knowledge base rating; (ii) a link to an external data entity; (iii) a link to a web site; and (iv) a link to a processor comprising a communications element.

In one embodiment of the invention, users of the system are able to access unbiased information and objective, standards-based, qualitative and quantitative evaluations, analyses, ratings, and recommendations, with respect to company, product and service resources within a specific industry for precise user needs, based upon user-based or user-defined criteria. In addition, users are able to access guidance and education in formulating their search and other queries. Further, users are able to query, communicate with, and transact business with, the providers of company, product and service resources within the specific industry. Users of the system that are resource providers are able to receive consulting, advisory, product development, advertising, marketing, sales, distribution, customer servicing, customer management, and similar services. Furthermore, resource users and resource providers within a specific industry are able to interact informally through online and offline events.

The invention is designed for application to specific industries. With respect to the financial services industry application, as an exemplary embodiment of the invention, knowledge base data content will include, for example, information and analyses on company, product and service resources with respect to the preservation, accumulation, transfer, divestiture, management, education and administration of financial and non-financial assets by individuals and by businesses, including, for example, and without limitation, company, product and service resources for financial, investment, trading, brokerage, asset management, commercial banking, investment banking, and transactional resource user needs.

The invention provides concrete, practical benefits to both resource users and resource providers within a specific industry, including, for example, and without limitation, one or more of the following benefits: (i) resource users are able to save time and money in sourcing and evaluating resources; reduce or eliminate undesirable service experiences; receive better pricing and/or performance from resource providers; and have more confidence and trust in, and a more satisfying relationship with, service providers; (ii) resource providers may receive market exposure through an independent, high-quality information source, thus extending their market reach and building their brand at low cost; (iii) the industry-specific resource evaluation standards established by the invention, assuming the invention is used by an ever-growing audience, may encourage resource providers to maintain high standards in product and service quality, price, and performance, thus benefiting the industry as a whole; and (iv) resource users and resource providers within a specific industry are able to interact informally, thus facilitating meaningful and enjoyable relationships, which is an important value in resource management and in our daily lives in general, and an increasingly sought-after experience in our society.

The detailed description set forth herein of exemplary embodiments of the invention makes reference to certain database and functional technology components, attributes, and processes, which show the exemplary embodiment by way of illustration and its best mode. While these exemplary embodiments are described in sufficient detail to enable those skilled in the art to practice the invention, it should be understood that other embodiments may be realized and that changes and modifications to these database and functional technology components, attributes, and processes may be made without departing from the spirit, scope, principles, and purposes of the invention.

Thus, the detailed description set forth herein of exemplary embodiments is presented for purposes of illustration only and not of limitation. For example, the invention contemplates various and distinct applications for specific industries as exemplary embodiments of the invention, and the database and functional technology components, attributes and processes may vary in form and substance for each of these exemplary embodiments. Further, the steps recited in any of the method or process descriptions may be executed in any order and are not limited to the order presented. It should be appreciated that the particular embodiments described herein are illustrative of the invention and its best mode and are not intended to otherwise limit the scope or purposes of the invention in any way.

The invention may be described herein in terms of functional components, optional selections, and various processing steps. It should be appreciated that such functional components may be realized by any number of software and/or hardware components configured to perform the specified functions. Moreover, it should be noted that, for the sake of brevity, certain sub-components of the invention may not be described in detail herein, such as conventional data processing, application development, and other conventional technology aspects of the invention.

As will be appreciated by one of ordinary skill in the art, the invention may be embodied as a method, a data processing system, a device for data processing, and/or a computer program product. Accordingly, the invention may take the form of an entirely software embodiment, an entirely hardware embodiment, or an embodiment combining aspects of both software and hardware. Moreover, the invention may take the form of an Internet-based computer program accessible by any computer device, including wireless devices, which have connectivity to the Internet. Further, the invention may take the form of a computer program product on a computer-readable storage medium having computer-readable program code means embodied in the storage medium. Any suitable computer-readable storage medium may be utilized, for example, hard disks, CD-ROMs, DVDs, optical storage devices, magnetic storage devices, flash memory devices, or any type of media or device suitable for storing instructions and/or data.

The software components of the invention may be implemented with any programming or scripting language, such as C, C++, Java, COBOL, PERL, Visual Basic, SQL Stored Procedures, or extensible markup language (XML), with the various algorithms being implemented with any combination of data structures, objects, processes, routines or other programming elements. Further, it should be noted that the invention may employ any number of conventional techniques for data transmission, signaling, data processing, network control, and the like. In addition, the software components of the invention may include, without limitation, device drivers, operating systems, execution environments, and/or user applications.

As used herein, the term “search parameter” means any parameter used in a search or query.

All references herein to the “WRM SYSTEM” refer to the invention in whole or in part and are not meant to limit or define the invention in any way. The invention may be called or assigned other names, nomenclature, or classification, without affecting any component, attribute, process, principle, or purpose of the invention in any way.

A. WRM System Information Technology Platform

A.1. ACCESS TO THE INVENTION: The Invention may be accessible via electronic networks and sites, computer application software, CD-ROMs, DVDs, and other suitable storage devices, remote access (mobile) software and hardware, and via consulting and advisory services. In an exemplary embodiment of the invention, the WRM SYSTEM, and/or components thereof, may be located on the Internet at various web addresses (hereinafter sometimes collectively referred to as the “WRM Web Sites”).

A.2. INVENTION DEVELOPMENT PROCESS: In an exemplary embodiment of the invention, the invention development process may be conducted by professional staff experienced in database development, database management and analysis, and industry market research, and may be conducted with assistance and/or input from third parties. Additionally or alternatively, certain database components and functional technology components may be developed, in whole or in part, by third parties and incorporated into the invention development process via license or other contractual arrangement. (Sections B, C, and D below provide further description of the invention development process.)

B. Invention Functionality

B.1. SEARCH AND QUERY CAPABILITIES: In an exemplary embodiment of the invention, the WRM SYSTEM will provide various search capabilities. The user will be able to perform search of the WRM SYSTEM Knowledge Base, or portions thereof, and/or of the Web, via WRM SYSTEM toolbars and querying taskbars, Web browser toolbars, and desktop toolbars. Toolbars and taskbars may have drop-down menus and may be customizable in settings and layout options. The user may be able to define, limit, and refine his search and queries by selecting various customized criteria and topical parameters. For example, topical parameters may include, without limitation, user needs with respect to a given activity, company, product, service, or Resource Provider Category (see Section C below for a description of Resource Provider Categories for the financial services industry application).

B.2. DATA CONTENT AND TECHNOLOGY DISTRIBUTION: In an exemplary embodiment of the invention, the WRM SYSTEM may distribute and receive content and technology in several ways, including, for example and without limitation, in one or more of the following ways:

B.2.a. Data Content Distribution to WRM SYSTEM Users: The user will be able to retrieve WRM SYSTEM data content by utilizing the WRM SYSTEM search toolbars and taskbars, as described in Section B.1 above. Additionally, the user may be able to receive WRM SYSTEM news and alerts based upon specific topics, categories, and/or other customized criteria.

B.2.b. Data Content Submission from WRM SYSTEM Resource Users: and Resource Providers: Resource Users and Resource Providers will be able to submit information and feedback to the WRM SYSTEM, including, for example and without limitation, via a feedback form, survey, blog, and/or event.

B.2.c. Data Content and Technology Distribution to and from Business Partners and Other Third Parties: WRM SYSTEM data content may be distributed to WRM SYSTEM business partners and other third parties via license or other contractual arrangement. In addition, WRM SYSTEM functional technology components, in whole or in part, may be licensed or transferred by contractual arrangement to business partners and other third parties. Furthermore, the WRM SYSTEM may incorporate data content, software, or other technology components from business partners and other third parties, via license or other contractual arrangement.

B.3. INTERACTIVE COMMUNICATION AND COLLABORATIVE CAPABILITIES: In an exemplary embodiment of the invention, the WRM SYSTEM may provide various types of interactive communication and collaborative capabilities for Resource Users and Resource Providers, including, for example and without limitation, by providing blogs, podcasts, email communication, and online events.

B.4. MARKETING AND ADVERTISING CAPABILITIES: In an exemplary embodiment of the invention, the WRM SYSTEM may provide marketing and advertising capabilities and services, including, for example and without limitation, advertising on WRM SYSTEM Web Sites, and user measurement and reporting tools.

B.5. TRANSACTIONAL CAPABILITIES: In an exemplary embodiment of the invention, the WRM SYSTEM may provide various types of transactional capabilities, including, for example and without limitation, web sites that enable direct purchase of Resource Provider products and services, and web sites that facilitate Resource Provider-to-Resource Provider business transactions.

B.6. WIRELESS CAPABILITIES: In an exemplary embodiment of the invention, the WRM SYSTEM may provide various types of wireless capabilities, including, for example and without limitation, accessibility via wireless devices that provide Web and/or other wireless connectivity, and via application software that may be downloaded onto wireless devices.

C. WRM SYSTEM KNOWLEDGE BASE: The WRM SYSTEM Knowledge Base comprises the database components of the WRM SYSTEM, and is an essential element of the invention. In an exemplary embodiment of the invention, the data content structure, the data content sources, and the data compilation process are designed to produce institutional-quality data content scope, depth, and integrity, as the strength of these attributes is the main determinant of the quality of company, product and service resource management. An exemplary embodiment of the data content structure, data content sources, and data content compilation process of the invention (hereinafter sometimes collectively referred to as the “Database Development Process”) is described below. The Database Development Process described below may be modified, amended, revised, and/or customized for specific industry applications of the invention, and said modifications, amendments, revisions, and/or customizations may be made without departing from the spirit, scope, principles, and purposes of the invention.

C.1. DATA CONTENT STRUCTURE: In an exemplary embodiment of the invention, the data content structure may contain a plurality of categories pertaining to Resource User products and services, Resource User needs, and Resource Provider needs, within a specific industry (hereinafter sometimes referred to as the “Data Content Structure”). With respect to the financial services industry application, as an exemplary embodiment of the invention, the Data Content Structure may contain one or more of the categories listed below, and may contain additional or revised categories as revised from time to time.

C.1.a. Categories of Resource Provider Products and Services: These categories will vary for each industry-specific application of the invention, and may be revised from time to time. With respect to the financial services industry application, as an exemplary embodiment of the invention, Resource Provider Categories may consist of categories such as: (A) Financial Asset Management Resources: Financial Planning, Insurance Services, Investment Banking, Investment Management, Private Banking, and Securities Brokerage; (B) Non-Financial Asset Management Resources: Art, Antique, and Collectible Auction Firms; Dealers and Galleries; and (C) Miscellaneous Resources: Travel Resources, Personal Shopping Resources.

C.1.b. Categories of Resource Provider Information and Analyses: These categories will vary for each industry-specific application of the invention, and may be revised from time to time. With respect to the financial services industry application, as an exemplary embodiment of the invention, the categories of Resource Provider information and analyses may contain some or all of the categories listed below, and the elements within each category in whole or in part, and may contain additional and/or revised categories as revised from time to time (said categories are hereinafter sometimes collectively referred to as the “Resource Provider Evaluation Criteria”).

Resource Provider Evaluation Criteria:

BUSINESS MODEL: Consisting of factors such as Business Strategy, Product Strategy, Product Pricing.

OPERATIONAL MODEL: Consisting of factors such as Organizational Structure, Staffing, Management Strength.

FINANCIAL METRICS: Consisting of factors such as Gross and Net Operating Margins, Debt/Equity Ratio, Return on Assets, Return on Equity.

CORPORATE GOVERNANCE: Consisting of factors such as Corporate Governance Policies and Procedures, Board Quality.

CUSTOMER SATISFACTION MEASUREMENT: Consisting of factors such as Product/Service Satisfaction, Client Service Satisfaction.

BASIC BUSINESS DATA: Consisting of factors such as Business Locations, Number of Employees, Business Description, Product and Service Description.

The number of Resource Provider Evaluation Criteria, and the nature and extent of the information and analyses within each Resource Provider Evaluation Criteria, for each Resource Provider may vary, depending upon factors such as (i) the Resource Provider's business category and business size; (ii) the availability of public and non-public information and analyses relating to the Resource Provider; and (iii) the information submitted by the Resource Provider to the WRM SYSTEM. The information and analyses within each Resource Provider Category (including for some or all of the Resource Providers within the Resource Provider Category) may be regularly updated in whole or in part.

C.1.c. Categories of Resource User Information and Analyses: These categories will vary for each industry-specific application of the invention, and may be revised from time to time. With respect to the financial services industry application, as an exemplary embodiment of the invention, the categories of Resource User information and analyses may contain some or all of the categories listed below, and may contain additional and/or revised categories as revised from time to time (said categories are hereinafter sometimes collectively referred to as the “Resource User Info Categories”).

Resource User Info Categories: Consisting of categories such as Resource User Need Trends, Resource User Profiles.

The nature and extent of the information and analyses within each Resource User Info Category may vary, depending upon factors such as (i) the availability of public and non-public information and analyses relating to the Resource User Category; and (ii) the information submitted by Resource Users to the WRM SYSTEM. The information and analyses within each Resource User Category may be regularly updated in whole or in part.

C.1.d. Categories of Industry and Market Information and Analyses: These categories will vary for each industry-specific application of the invention, and may be revised from time to time. With respect to the financial services industry application, as an exemplary embodiment of the invention, the categories of industry and market information and analyses may contain some or all of the categories listed below, and may contain additional and/or revised categories as revised from time to time (said categories are hereinafter sometimes collectively referred to as the “Industry Info Categories”).

Industry Info Categories: Consisting of categories such as Industry Sector Trends, Customer Market Trends.

The nature and extent of the information and analyses within each Industry Info Category will vary, depending upon factors such as (i) the availability of public and non-public information and analyses relating to the Industry Info Category; and (ii) the information submitted by Resource Providers and Resource Users to the WRM SYSTEM. The information and analyses within each Industry Info Category may be regularly updated in whole or in part.

C.2. DATA CONTENT SOURCES: In an exemplary embodiment of the invention, the data content sources may consist of several types of data sources which may vary for each industry-specific application of the invention and which may be revised from time to time (hereinafter sometimes referred to as the “Data Content Sources”). With respect to the financial services industry application, as an exemplary embodiment of the invention, Data Content Sources may contain some or all of the types of sources listed below, and may contain additional or revised types of sources as revised from time to time.

Types of Data Content Sources: Consisting of sources such as (1) public information, including, without limitation, regulatory and other public filings; and company, industry, and news web sites; (2) data submitted by Resource Providers, Resource Users, business partners, and third parties; and (3) data internally developed from WRM System Web Site user and visitor traffic.

C.3. DATA CONTENT COMPILATION AND INPUT: In an exemplary embodiment of the invention, the data content compilation and input process (hereinafter sometimes referred to as the “Data Compilation Process”) may utilize conventional data processing methods, tools, and techniques for data cleansing, data normalization, data mapping, and schema classification and definition, implemented utilizing automated and/or manual processes. The Data Compilation process may vary for each industry-specific application of the invention and may be revised from time to time. With respect to the financial services industry application, as an exemplary embodiment of the invention, the Data Compilation Process may be conducted manually by professional staff experienced in industry market research and/or data management and analysis, with assistance and/or input from third parties, and by automated processes.

D. RULE SETS: In an exemplary embodiment of the invention, the WRM SYSTEM Rule Sets (hereinafter sometimes collectively referred to as the “Rule Sets”) are developed by professional staff experienced in industry market research and/or data management and analysis, and may be developed with input from third parties. The development process may vary for each industry-specific application of the invention and may be revised from time to time.

The Rule Sets may vary for each industry-specific application of the invention, and may be revised from time to time. Also, the Rule Sets for each type of resource within an industry-specific application may vary, and may be revised from time to time. Also, the factors, ratios, and values in the Rule Sets may vary, for example, depending on the industry-specific application of the invention and/or the type of resource, and may be revised from time to time.

The Rule Sets may incorporate, for example and without limitation, (i) database content (described in Section C above); (ii) business rules and multi-factor analytical equations, such as cause-and-effect equations and econometric modeling; and (iii) other conventional data modeling and analysis components and techniques, such as concept descriptions, classification models, parameter files, decision trees, regression and factor analysis models, multivariate statistical models, linguistics-based text mining technologies, and industry standard methodologies for data mining and data analysis (such as CRISP-DM, the Cross Industry Standard Process model for Data Mining). One or more of these components may incorporate, via license or other contractual arrangement, data and/or software code developed by third parties.

In an exemplary embodiment of the invention, the Rule Sets may incorporate one or more equations, factors, ratios, and values embodying at least one of: (a) multi-factor resource evaluation criteria applicable to at least one of the following: business model, operational model, corporate governance, financial metrics, customer satisfaction measurement, and basic business data; (b) industry information and analysis; (c) industry standards; (d) industry policies; (e) industry procedures; (f) best practice standards; and (g) standard operating procedures. The foregoing content may be developed by professional staff and/or by professional staff in conjunction with third parties.

For example, a Rule Set may embody a Resource Provider Evaluation Model comprised of certain Resource Provider Evaluation Criteria (described in Section C above) and certain factors, ratios, and values assigned to the Resource Provider Evaluation Criteria, for the purpose of evaluating a specific Resource Provider or a specific Resource Provider Product or Service Category.

The Rule Sets may enable various types of functional results, which may vary for each industry-specific application of the invention and/or for each type of resource, and which may be revised from time to time. Functional results may include, for example and without limitation, qualitative and/or quantitative rating and ranking of company, product, and service resources, based upon user-based, user-specified, and/or other customized parameters and criteria.

Closing Remarks:

The Diagrams appended hereto are intended to provide a simple illustration of only a portion of the functions, components, attributes, and processes of the invention, and do not illustrate many of the functions, components, attributes, and processes of the invention described in this detailed description. Accordingly, said Diagrams are not intended to limit or define the invention, or otherwise to limit the scope or purposes of the invention in any way.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all of the Claims. As used herein, the terms “consists of,” “contains,” “comprised of”, “comprises”, or any related terms and/or other variations thereof, are intended to cover a non-exclusive inclusion, such that a process, method, functional component, or other system component that comprises a list of elements does not include only those elements but may include other elements not expressly listed or inherent to such process, method, functional component, or other system component. Further, no element described herein is required for the practice of the invention unless expressly described herein as “essential” or “critical”.

In summary, the invention provides a disciplined approach to industry-specific resource sourcing, evaluation, purchase, management, education and administration (sometimes collectively referred to herein as “resource management”), utilizing an organized method and system that provides comprehensive, accurate, and detailed search results so that the individual or business resource user can make informed, intelligent, efficient, and timely decisions in his resource management at his convenience and at a low or minimal cost. Because the invention's application is intended to be customized for industry-specific needs, the invention is able to address the user's customized resource management needs and provide him with the specialized information necessary for the user to make the right resource choices for the user's particular needs as they may change from time to time. Additionally, in an exemplary embodiment of the invention, the invention also allows for standardization of resource evaluation across the general user community in specific industries, by providing resource evaluations based upon industry-specific standardized criteria.

In summary, the invention effectively addresses the costly, time-consuming, difficult, and complex process of company, product and service resource management in our modern age for both the individual and business consumer, and provides a convenient, economical, practical, and effective business solution to this problem.

The foregoing detailed description of the invention has been presented for purposes of illustration and description. It is not intended to be exhaustive or to limit the invention to the precise forms disclosed. Many modifications and variations are possible in light of the above teaching. The embodiments of the invention described herein were chosen in order to best explain the principles of the invention and its practical application, to thereby enable others skilled in the art to best utilize the invention in various embodiments and with various modifications as are suited to the particular use contemplated. It is intended that the scope of the invention be defined by the Claims appended hereto, which themselves recite those features regarded as essential to the invention.

### EXAMPLES

Examples 1 and 2 are examples of a user search process and search results for the Financial Services Industry:

### Example 1

User #1 has $100,000 to invest in stocks and bonds and wants to find out the best way to accomplish this goal. He selects the “Investment Management: $100,000-$1 million” search parameter of the system, which triggers an Activity Rule Set comprised of a set of dynamic rules and analytic equations which embody industry knowledge applicable to the activity embodied in the search parameter. Here, the Activity Rule Set would embody factors such as: investment time horizon, length of prior investment experience, and trading preferences. This Activity Rule Set generates a User Query Set comprised of queries such as: (i) is your investment time horizon less than 1 year, 1-3 years, or more than 3 years; (ii) is the length of your prior investment experience less than one year, 1-5 years, or more than 5 years; and (iii) do you prefer self-directed investments or the services of a securities broker or investment manager.

In this example, the User Query Set responses indicate that the user has a time horizon of 1-3 years, more than 5 years prior experience, and prefers self-directed investments. These User Query Set responses trigger a User Need Rule Set comprised of a set of dynamic rules and analytic equations which embody industry knowledge applicable to the user needs embodied in the User Query Set. Here, the User Need Rule Set would embody factors such as: (i) intermediate-level industry education needs for a self-directed investor; (ii) resource provider service needs comprised of online securities brokerage, trading, and research functions; and (iii) information and communication needs with respect to online securities brokerage and trading firms.

This User Need Rule Set triggers a Knowledge Base Analysis Rule Set comprised of a set of dynamic rules and analytic equations which embody industry knowledge for fulfilling the user needs embodied in the User Query Set responses. Here, the Knowledge Base Analysis Rule Set would embody factors such as: (i) industry education comprised of description of the main online securities brokerage and trading firms and their services and pricing, and sources of relevant industry news, newsletters, blogs, podcasts, and research and trading tools for an experienced, self-directed investor; (ii) evaluation of the main online securities brokerage and trading firms, based upon such factors as account and transaction costs, trading technology platform speed and functionality, and quality of research; and (iii) information and communication options with respect to these main online securities brokerage and trading firms.

This Knowledge Base Analysis Rule Set is applied to the knowledge base to generate a result set comprised of: (i) knowledge base data content comprised of (a) basic business data and description on the main online securities brokerage and trading firms, including services and pricing, and (b) web site and email links to certain sources of industry news, newsletters, blogs, podcasts, and research and trading tools for an experienced, self-directed investor; (ii) rating and ranking of the main online securities brokerage and trading firms, based upon such factors as account and transaction costs, trading technology platform speed and functionality, quality of research, and customer service; and (iii) web site links, email links, Internet telephony links, and other contact information with respect to these main online securities brokerage and trading firms.

### Example 2

User #2 has $10 million to invest in portfolio investments and wants to find out the best way to accomplish this goal. He selects the “Investment Management: $10 million-$25 million”” activity search parameter of the system, which triggers an Activity Rule Set comprised of a set of dynamic rules and analytic equations which embody industry knowledge applicable to the activity embodied in the search parameter. Here, the Activity Rule Set would embody factors such as: type of prior investment experience, use of portfolio managers and advisors, and asset class preferences. This Activity Rule Set generates a User Query Set comprised of queries such as: (i) in what asset classes have you previously invested: stocks, bonds, real estate, hedge funds, private equity, and/or other; (ii) have you previously used the services of a registered investment advisor, certified financial advisor, investment consultant, and/or other investment advisor; and (iii) do you now prefer to invest in stocks, bonds, real estate, hedge funds, private equity, and/or other.

In this example the User Query Set responses indicate that the user has previously invested in stocks and bonds; has not previously used the services of a registered investment advisor, certified financial advisor, investment consultant, or other investment advisor; and now prefers to invest in stocks and hedge funds. These User Query Set responses trigger a User Need Rule Set comprised of a set of dynamic rules and analytic equations which embody industry knowledge applicable to the user needs embodied in the User Query Set. Here, the User Need Rule Set would embody factors such as: (i) industry education needs with respect to high net worth portfolio management; (ii) resource provider service needs encompassing registered investment advisors, certified financial advisors, and alternative investment consultants; and (iii) information and communication needs with respect to registered investment advisors, certified financial advisors, and alternative investment consultants.

This User Need Rule Set triggers a Knowledge Base Analysis Rule Set comprised of a set of dynamic rules and analytic equations which embody industry knowledge for fulfilling the user needs embodied in the User Query Set responses. Here, the Knowledge Base Analysis Rule Set would embody factors such as: (i) industry education comprised of description of the main types of service providers for a $10M investment portfolio, and description of their services and fee structure; (ii) selection of certain registered investment advisors, certified financial advisors, and alternative investment consultants, based upon close geographic location to the user; (iii) evaluation of these selected registered investment advisors, certified financial advisors, and alternative investment consultants, based upon such factors as prior investment performance, reputation, and quality of service; and (iv) information and communication options with respect to these selected registered investment advisors, certified financial advisors, and alternative investment consultants.

This Knowledge Base Analysis Rule Set is applied to the knowledge base to generate a result set comprised of: (i) knowledge base data content comprised of a detailed description of each type of service provider for a $10M investment portfolio, including typical services and fee structures; and web site and email links other contact information for industry education sources comprised of newsletters, blogs, podcasts, conferences, seminars, and industry organizations; (ii) selection of certain registered investment advisors, certified financial advisors, and alternative investment consultants, based upon close geographic location to the user; (iii) rating and ranking of these selected registered investment advisors, certified financial advisors, and alternative investment consultants, based upon such factors as length of experience, reputation, and quality of service; and (iv) web site links, email links, and Internet telephony links with respect to these selected registered investment advisors, certified financial advisors, and alternative investment consultants.

Examples 3 and 4 are examples of knowledge base data content structure changes (category, rule set, search parameter, and/or data source) based upon updated knowledge base data content.

In example #3, the new knowledge base data content consists of new SEC regulations requiring hedge funds of a certain size to register with the SEC and to provide certain information. This new data content triggers two requirements with respect to knowledge base data content structure changes:

(1) A requirement to update the Knowledge Base Analysis Rule Set applicable to the hedge fund resource provider category, specifically, to add an evaluation factor in the Resource Provider Evaluation Model (embodied in the Knowledge Base Analysis Rule Set), applicable to the Hedge Fund Resource Provider Category, that requires compliance with this new SEC registration requirement; and

(2) A requirement to add a new data source, namely, the SEC web site(s) listing new and existing hedge fund registrations.

In example #4, the new knowledge base data content consists of new information submitted by a WRM SYSTEM Resource Provider. The new information indicates that the Resource Provider has discontinued certain services, has added new services, and has made certain management changes. This new data content triggers two requirements with respect to knowledge base data content structure changes:

(1) A requirement to re-assess this Resource Provider with respect to these service and management changes, and to incorporate this re-assessment in updating the Knowledge Base Analysis Rule Set applicable to this Resource Provider, specifically, to update the Resource Provider Evaluation Model factors, ratios, and values (embodied in the Knowledge Base Analysis Rule Set) assigned to this Resource Provider, based upon this re-assessment; and

(2) A requirement to assess whether a new knowledge base resource provider service category, a new search parameter, and/or a new data source(s), pertaining to the new services provided by this Resource Provider, should be added to the knowledge base data content structure.

1. A computer-implemented method for creating and maintaining a search knowledge-based system with respect to company, service and product resources within a specific industry, using a knowledge base data content structure comprised of a plurality of categories, a plurality of rule sets, a plurality of search parameters, a plurality of data sources, and data content input from the plurality of data sources; the rule sets comprising a plurality of user need rule sets, the method comprising the steps of:
(a) accepting at least one search parameter from a user;
(b) generating at least one user query set based upon the at least one search parameter;
(c) assigning at least one user need rule set to each user query set, the user need rule set embodying industry knowledge applicable to the user needs embodied in the user query set; and
(d) displaying the at least one user query set to the user.

2. The computer-implemented method of claim 1, further comprising:
(e) receiving user query set responses from the user in response to queries in the at least one user query set;
(f) applying the at least one user need rule set to the user query set responses to generate at least one knowledge base analysis rule set which embodies industry knowledge for fulfilling the user needs embodied in the user query set responses;
(g) running the at least one knowledge base analysis rule set applicable to the user query set responses on the knowledge base to generate at least one result set; and
(h) outputting the at least one result set.

3. The computer-implemented method of claim 2, wherein the result set is comprised of at least one of the following: (i) at least one of knowledge base data content, knowledge base analysis, knowledge base ranking, and knowledge base rating; (ii) a link to data stored in an external data entity; (iii) a link to a web site; and (iv) a link to a processor comprising a communications element.

4. The computer-implemented method of claim 1, in which the rule sets further comprise a plurality of activity rule sets, each activity rule set being assigned to at least one search parameter and embodying industry knowledge applicable to the activity embodied in the search parameter; and the user query sets are generated by:
(a) selecting at least one activity rule set based upon the at least one search parameter;
(b) generating at least one user query set based upon the at least one activity rule set.

5. The computer-implemented method of claim 1, wherein at least one of the rule sets incorporates one or more equations, factors, ratios, and/or values embodying at least one of: (a) resource evaluation criteria applicable to at least one of the following: business model, operational model, corporate governance, financial metrics, customer satisfaction measurement, and basic business data; (b) industry information and analysis; (c) industry standards; (d) industry policies; (e) industry procedures; (f) best practice standards; and (g) standard operating procedures.

6. The computer-implemented method of claim 1, further comprising the step of updating the knowledge base data content by at least one of adding, modifying, and deleting data content based upon at least one of (i) new data content input from the plurality of data sources, and (ii) new data content input from a new data source added to the plurality of data sources.

7. The computer-implemented method of claim 1, further comprising the step of updating the knowledge base data content structure by at least one of adding, modifying, and deleting at least one of the plurality of categories, the plurality of rule sets, the plurality of search parameters, and the plurality of data sources, based upon at least one of (i) new data content input from the plurality of data sources, and (ii) new data content input from a new data source added to the plurality of data sources.

8. A computer-implemented method for creating and maintaining a search knowledge-based system with respect to company, service and product resources within a specific industry, using a knowledge base data content structure comprised of a plurality of categories, a plurality of rule sets, a plurality of search parameters, a plurality of data sources, and data content input from the plurality of data sources; the rule sets comprising a plurality of user need rule sets, in which at least one search parameter is accepted from a user, at least one user query set is generated based upon the at least one search parameter, at least one user need rule set is assigned to each user query set, the user need rule set embodying industry knowledge applicable to the user needs embodied in the user query set, and the at least one user query set is displayed to the user for response, the method comprising the steps of:
(a) receiving user query set responses from a user in response to queries in the at least one user query set;
(b) applying the at least one user need rule set to the user query set responses to generate at least one knowledge base analysis rule set which embodies industry knowledge for fulfilling the user needs embodied in the user query set responses;
(c) running the at least one knowledge base analysis rule set applicable to the user query set responses on the knowledge base to generate at least one result set; and
(d) outputting the at least one result set.

9. The computer-implemented method of claim 8, in which the rule sets further comprise a plurality of activity rule sets, each activity rule set being assigned to at least one search parameter and embodying industry knowledge applicable to the activity embodied in the search parameter; and the user query sets are generated by:
(a) selecting at least one activity rule set based upon the at least one search parameter;
(b) generating at least one user query set based upon the at least one activity rule set.

10. The computer-implemented method of claim 8, wherein at least one of the rule sets incorporates one or more equations, factors, ratios, and/or values embodying at least one of: (a) resource evaluation criteria applicable to at least one of the following: business model, operational model, corporate governance, financial metrics, customer satisfaction measurement, and basic business data; (b) industry information and analysis; (c) industry standards; (d) industry policies; (e) industry procedures; (f) best practice standards; and (g) standard operating procedures.

11. The computer-implemented method of claim 8, wherein the result set is comprised of at least one of the following: (i) at least one of knowledge base data content, knowledge base analysis, knowledge base ranking, and knowledge base rating; (ii) a link to data stored in an external data entity; (iii) a link to a web site; and (iv) a link to a processor comprising a communications element.

12. A computer-implemented method for creating and maintaining a search knowledge-based system with respect to company, service and product resources within a specific industry, using a knowledge base data content structure comprised of a plurality of categories, a plurality of rule sets, a plurality of search parameters, a plurality of data sources, and data content input from the plurality of data sources; the rule sets comprising a plurality of activity rule sets and a plurality of user need rule sets, each activity rule set being assigned to at least one search parameter and embodying industry knowledge applicable to the activity embodied in the search parameter; the method comprising the steps of:
(a) accepting at least one search parameter from a user;
(b) selecting at least one activity rule set based on the at least one search parameter;
(c) generating at least one user query set based upon the at least one activity rule set;
(d) assigning at least one user need rule set to each user query set, the user need rule set embodying industry knowledge applicable to the user needs embodied in the user query set,
(e) displaying the at least one user query set to the user;
(f) receiving user query set responses from the user in response to queries in the at least one user query set;
(g) applying the at least one user need rule set to the user query set responses to generate at least one knowledge base analysis rule set which embodies industry knowledge for fulfilling the user needs embodied in the user query set responses;
(h) running the at least one knowledge base analysis rule set applicable to the user query set responses on the knowledge base to generate at least one result set; and
(i) outputting the at least one result set.

13. The computer-implemented method of claim 12, wherein at least one of the rule sets incorporates one or more equations, factors, ratios, and/or values embodying at least one of: (a) resource evaluation criteria applicable to at least one of the following: business model, operational model, corporate governance, financial metrics, customer satisfaction measurement, and basic business data; (b) industry information and analysis; (c) industry standards; (d) industry policies; (e) industry procedures; (f) best practice standards; and (g) standard operating procedures.

14. The computer-implemented method of claim 12, further comprising the step of updating the knowledge base data content by at least one of adding, modifying, and deleting data content based upon at least one of (i) new data content input from the plurality of data sources, and (ii) new data content input from a new data source added to the plurality of data sources.

15. The computer-implemented method of claim 12, further comprising the step of updating the knowledge base data content structure by at least one of adding, modifying, and deleting at least one of the plurality of categories, the plurality of rule sets, the plurality of search parameters, and the plurality of data sources, based upon at least one of (i) new data content input from the plurality of data sources, and (ii) new data content input from a new data source added to the plurality of data sources.

16. The computer-implemented method of claim 12, wherein the result set is comprised of at least one of the following: (i) at least one of knowledge base data content, knowledge base analysis, knowledge base ranking, and knowledge base rating;
(ii) a link to data stored in an external data entity; (iii) a link to a web site; and (iv) a link to a processor comprising a communications element.

17. The computer-implemented method of claim 12, further comprising the step of:
(i) storing a user search history of a user of the system in the knowledge base;
(k) producing at least one of a user analysis and a user profile, based upon the user search history;
(l) storing the at least one of the user analysis and the user profile in the knowledge base; and
(m) storing the at least one of the user search history, the user profile, and the user analysis in the knowledge base as one of the plurality of data sources in the knowledge base data content structure.

18. A computer-implemented search knowledge-based system, comprising:
a) a computer-readable knowledge base having a data content structure comprised of:
i) a plurality of categories,
ii) a plurality of rule sets comprising a plurality of user need rule sets,
iii) a plurality of search parameters,
iv) a plurality of data sources, and
v) data content input from the plurality of data sources;
b) at least one processor coupled to the knowledge base and comprising a communications element communicating with at least one user; the processor being programmed such that the processor:
(i) accepts at least one search parameter from a user through the communications element;
(ii) generates at least one user query set based upon the at least one search parameter;
(iii) assigns at least one user need rule set to each user query set, the user need rule set embodying industry knowledge applicable to the user needs embodied in the user query set; and
(iv) displays the at least one user query set to the user through the communications element.

19. The computer-implemented system of claim 18, in which the processor is further programmed such that the processor:
(v) receives user query set responses from the user through the communications element, in response to queries in the at least one user query set;
(vi) applies the at least one user need rule set to the user query set responses to generate at least one knowledge base analysis rule set which embodies industry knowledge for fulfilling the user needs embodied in the user query set responses;
(vii) runs the at least one knowledge base analysis rule set applicable to the user query set responses on the knowledge base to generate at least one result set; and
(viii) outputs the at least one result set to the user through the communications element.

20. The computer-implemented system of claim 19, wherein the result set is comprised of at least one of the following: (i) at least one of knowledge base data content, knowledge base analysis, knowledge base ranking, and knowledge base rating; (ii) a link to data stored in an external data entity; (iii) a link to a web site; and (iv) a link to a processor comprising a communications element.

21. The computer-implemented system of claim 18, in which the rule sets further comprise a plurality of activity rule sets, each activity rule set being assigned to at least one search parameter and embodying industry knowledge applicable to the activity embodied in the search parameter; and the processor is further programmed to generate user query sets by:
(a) selecting at least one activity rule set based on the at least one search parameter;
(b) generating at least one user query set based upon the at least one activity rule set.

22. The computer-implemented system of claim 18, wherein at least one of the rule sets incorporates one or more equations, factors, ratios, and/or values embodying at least one of: (a) resource evaluation criteria applicable to at least one of the following: business model, operational model, corporate governance, financial metrics, customer satisfaction measurement, and basic business data; (b) industry information and analysis; (c) industry standards; (d) industry policies; (e) industry procedures; (f) best practice standards; and (g) standard operating procedures.

23. A computer-implemented search knowledge-based system, comprising:
a) a computer-readable knowledge base having a data content structure comprised of:
i) a plurality of categories,
ii) a plurality of rule sets,
iii) a plurality of search parameters,
iv) a plurality of data sources, and
v) data content input from the plurality of data sources;
the rule sets comprising a plurality of activity rule sets and a plurality of user need rule sets, each activity rule set being assigned to at least one search parameter and embodying industry knowledge applicable to the activity embodied in the search parameter;
b) at least one processor coupled to the knowledge base and comprising a communications element communicating with at least one user; the processor being programmed such that the processor:
(i) accepts at least one search parameter from a user through the communications element;
(ii) selects at least one activity rule set based on the at least one search parameter;
(iii) generates at least one user query set based upon the at least one activity rule set;
(iv) assigns at least one user need rule set to each user query set, the user need rule set embodying industry knowledge applicable to the user needs embodied in the user query set;
(v) displays the at least one user query set to the user through the communications element;
(vi) receives user query set responses from the user through the communications element, in response to queries in the at least one user query set;
(vii) applies the at least one user need rule set to the at least one user query set responses to generate at least one knowledge base analysis rule set which embodies industry knowledge for fulfilling the user needs embodied in the user query set responses;
(viii) runs the at least one knowledge base analysis rule set applicable to the user query set responses on the knowledge base to generate at least one result set; and
(ix) outputs the at least one result set to the user through the communications element.

24. The computer-implemented system of claim 23, wherein at least one of the rule sets incorporates one or more equations, factors, ratios, and/or values embodying at least one of: (a) resource evaluation criteria applicable to at least one of the following: business model, operational model, corporate governance, financial metrics, customer satisfaction measurement, and basic business data; (b) industry information and analysis; (c) industry standards; (d) industry policies; (e) industry procedures; (f) best practice standards; and (g) standard operating procedures.

25. The computer-implemented system of claim 23, wherein the result set is comprised of at least one of the following: (i) at least one of knowledge base data content, knowledge base analysis, knowledge base ranking, and knowledge base rating; (ii) a link to data stored in an external data entity; (iii) a link to a web site; and (iv) a link to a processor comprising a communications element.
